(19) United States
(12) Patent Application Publication
(10) Pub. No.: US 2024/0297546 A1
(43) Pub. Date: Sep. 5, 2024

(54) ROTOR DEVICE FOR AN EXTERNALLY EXCITED ELECTRIC MACHINE

(71) Applicant: Dr. Ing. h.c. F. Porsche Aktiengesellschaft, Stuttgart (DE)

(72) Inventors: Florian BRAUNBECK, Bietigheim-Bissingen (DE); Rolf GRAEF, Kornwestheim (DE)

(21) Appl. No.: 18/589,451

(22) Filed: Feb. 28, 2024

(30) Foreign Application Priority Data
Mar. 2, 2023 (DE) 10 2023 105 142.3

(51) Int. Cl. H02K 3/32; H02K 1/24; H02K 3/24

(52) U.S. Cl. CPC H02K 3/325; H02K 1/24; H02K 3/24

(57) ABSTRACT

A rotor device for an externally excited electric machine, including at least one rotor with a rotor base body with a plurality of rotor teeth. Axially extending receiving grooves are arranged for receiving at least one winding portion of a rotor winding wound on the rotor teeth between the rotor teeth. A filling for fixing the rotor winding is arranged in the receptacle grooves. The rotor teeth include at least one collar portion at their radially outer end, which positively secures the filling in the receiving groove.

### CROSS REFERENCE TO RELATED APPLICATIONS

This application claims benefit to German Patent Application No. DE 10 2023 105 142.3, filed on Mar. 2, 2023, which is hereby incorporated by reference herein.

### FIELD

The present invention relates to a rotor device for an externally excited electric machine.

### BACKGROUND

Rotor devices are typically used for externally excited synchronous motors. A particular advantage of such motors is that costly permanent magnets can be dispensed with.

In the manufacture of such rotor devices, the receiving grooves are typically provided with an additional component in order to fix the winding portions received therein. The receiving grooves are then typically closed with a cover slide. Finally, the rotor winding and the receiving grooves are impregnated or cast with a resin.

For example, an externally excited motor configured as a universal motor is known from WO 2004 008 603 A2. In the rotor shown therein, coil windings, a commutator and a rotor shaft are at least in sections over-molded with a plastic material.

### SUMMARY

In an embodiment, the present disclosure provides a rotor device for an externally excited electric machine, comprising at least one rotor with a rotor base body with a plurality of rotor teeth. Axially extending receiving grooves are arranged for receiving at least one winding portion of a rotor winding wound on the rotor teeth between the rotor teeth. A filling for fixing the rotor winding is arranged in the receptacle grooves. The rotor teeth comprise at least one collar portion at their radially outer end, which positively secures the filling in the receiving groove.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a purely schematic illustration of a rotor device according to an embodiment of the invention in a sectioned front view;

FIG. 2 is a detailed representation of an embodiment of a rotor device according to the invention in a sectioned front view; and

FIG. 3 is a detailed representation of an embodiment of a rotor device according to the invention in a sectioned front view.

### DETAILED DESCRIPTION

In an embodiment, the present invention provides a rotor device for an externally excited electric machine having at least one rotor with a rotor base body with a plurality of rotor teeth. Between the rotor teeth, axially extending receptacle grooves are arranged for receiving at least one winding portion of a rotor winding wound on the rotor teeth

In an embodiment, the invention provides an improved rotor device. In particular, the rotor device should be constructed to be as light and compact as possible and at the same time be particularly powerful. In addition, the rotor device should be easy to construct and economical to manufacture.

The rotor device according to an embodiment of the invention is provided for an externally excited electric machine, and in particular for an externally excited synchronous motor. The rotor device can also be provided for an asynchronous motor. The rotor device comprises at least one (externally excited) rotor with a rotor base body, wherein the rotor base body is a plurality of rotor teeth (distributed around the circumference and extending in the radial and axial direction). Receptacle grooves for receiving at least one winding portion are arranged between the rotor teeth. The winding portion belongs to a rotor winding wound on the rotor teeth. A filler for fixing the rotor winding is arranged in the receiving grooves. The rotor teeth each comprise at least one collar portion at their radially outer end. The collar portion positively secures the cured filling in the at least one receptacle groove (associated with the rotor tooth of the collar portion).

The rotor device according to an embodiment of the invention offers many advantages. A significant advantage is offered by the filling arranged in the receiving grooves in combination with its positive securing by the collar portions of the rotor teeth. The otherwise common additional component and the cover slides can thus be omitted, for example. Components and also weight as well as design space can thus be saved. In addition, the manufacture of the rotor device is significantly simplified. For example, the assembly of the additional components for the winding fixation and the assembly of the cover slides are replaced by the insertion of the filling or by a molding step. Overall, the rotor device can therefore be made lighter and more compact and at the same time be implemented in a constructively simple manner and manufactured economically.

Preferably, the collar portions of the rotor teeth positively secure the filler against the centrifugal forces occurring during the intended operation. In particular, the filling is suitable and configured to withstand these centrifugal forces. In particular, the collar portions are suitable and configured to absorb the centrifugal forces and in particular to divert them radially inwards via the support portions. In particular, the collar portion extends over at least one part and preferably over the entire axial length of the receptacle groove and/or the support portion.

In particular, the filling also extends at least in sections radially below the collar portions. In particular, the filling is suitable and configured to replace a cover slide arranged between the rotor teeth and/or a component positively inserted in between the rotor teeth to cover the receptacle groove.

Preferably, the rotor teeth each comprise at least one support portion, which limits the receiving grooves in the circumferential direction of the rotor. The winding portion received in the receiving groove extends in particular on the support portion. In particular, the collar portion adjoins the support portion radially outwards. In particular, the collar portion projects beyond the support portion in the circumferential direction. In particular, the collar portion projects beyond the receiving groove in sections in a circumferential direction. In particular, the collar portion partially closes the receptacle groove radially outwards.

In particular, the collar portion projects beyond the support portion on both sides in the circumferential direction. In other words, the collar portion projects clockwise and counterclockwise in the circumferential direction beyond the support portion. In particular, the support portion and the collar portion together form a T-shaped cross-sectional profile of the rotor tooth (relative to a cross-section cut transverse to the axial direction).

It is preferred and advantageous that the filling has bridge surfaces. In particular, the bridge surfaces each extend between the collar portions of adjacent rotor teeth in the circumferential direction. In particular, the bridge surfaces fit closely to the collar portions without touching them. In particular, the bridge surfaces are configured to be exposed. In particular, the bridge surfaces do not fit positively against the collar portions.

Preferably, the bridge surfaces are each recessed (radially inwards). In particular, the bridge surfaces are each suitable and configured to make possible a targeted transfer of force from the filling into the rotor base body.

It is preferred and advantageous that the respective bridge surface is recessed (radially inwards) with respect to the maximum (radial) diameter of the filling. The recess is particularly related to an outer circumferential line of the filling. However, the bridge surface can also be flush with the circumferential line.

The bridge surfaces preferably each comprise at least one radially inwardly curved trough. In particular, the trough is concave. In particular, the trough reaches its maximum height at the collar portions. In particular, the trough reaches its maximum depth (centrally) between the collar portions. In particular, the trough runs in the axial direction or parallel to the longitudinal axis of the receptacle groove.

In an advantageous embodiment, the bridge surfaces are each curved radially inwards in a parabolic shape. In particular, the trough is curved radially inwards in a parabolic shape.

It is also advantageous for the bridge surfaces to each run radially inwards in a V-shape. In particular, the trough runs radially inwards in a V-shape. In particular, the trough has side surfaces that meet at a deepest point of the trough at an acute or obtuse angle. In particular, the side surfaces are planar (flat). The side surfaces can also be curved at least in sections.

In an advantageous configuration, it is provided that the bridge surfaces each comprise a bionically optimized geometry. In particular, the respective bridge surface regresses with a bionically optimized geometry. In particular, the trough has a bionically optimized geometry. For example, the geometries described above serve as the basis for such a bionic optimization. In particular, the geometry of the bridge surface (preferably its cross-sectional structure) is bionically calculated.

In particular, the design paradigms for supporting structures of living nature are applied to the large body structure for bionic optimization. In particular, the filling is arranged where the loads to be expected during operation of the rotor device are greater. In particular, the filling is omitted where the expected loads are lower. In particular, the geometry of the bridge surface is optimized for weight and stability.

It is advantageous and preferable that the collar portions project beyond the bridge surfaces in sections, the bridge surfaces being spaced apart from the collar portions opposite. In particular, the respective bridge surface runs below the collar portions and at a distance to the collar portions. However, it is also possible that the bridge surface is only configured between the opposing collar portions. Then, the collar portions do not project beyond the bridge surface, the bridge surface being spaced apart from the collar portions. In particular, the bridge surface does not then run below the collar portions.

In an advantageous embodiment, at least one cooling channel for cooling the rotor is configured in the filling. Preferably, at least one cooling channel runs in the filling in at least some of the receiving grooves. For example, at least one cooling channel is formed in each or every second or third or fourth receiving groove in the filling. The receiving grooves can each comprise at least two or three or four or more cooling channels.

In particular, the cooling channel runs in the axial direction or in the longitudinal direction of the receptacle groove. The cooling channel is in particular used to cool the winding portions. The cooling channel is located in particular between the support portions and radially further inwards than the collar portions. In particular, the cooling channel runs between adjacent winding portions. In particular, the cooling channel is configured for a liquid cooling fluid.

The filling and the at least one cooling channel can be simultaneously reshaped using the same casting method. In particular, the at least one cooling channel is produced by cutting it out with an appropriate tool during the casting of the filling. In particular, the filling and the cooling channel are produced by transfer molding or similar primary molding processes. However, it is also possible that the cooling channel is produced after the filling has been molded. For example, the filling is then removed locally so that the cooling channel is carved out.

In particular, the rotor device comprises at least one rotor shaft. Preferably, the at least one cooling channel can be supplied with a (liquid) cooling fluid via a supply channel running in the rotor shaft. In particular, the rotor shaft is connected to the rotor in a rotationally fixed manner. In particular, the rotor shaft is rotatably mounted relative to a stator. In particular, at least one flow connection extends between the supply channel and the at least one cooling channel.

It is preferred and advantageous that the at least one cooling channel is configured at least in sections (radial) below the bridge surface. In particular, the longitudinal axis of the cooling channel runs parallel to the longitudinal axis of the trough, at least in sections. In particular, the at least one cooling channel is located at least in sections on an imaginary line extending from the center of the bridge surface to the rotor shaft. In particular, the cooling channel is close to the bridge surface. It is provided that all cooling channels provided in a receiving groove are arranged below the bridge surface.

It is advantageous and preferable that the filling embeds the winding portions and (fully) fills a space between the winding portions running in a common receptacle groove. In particular, the filling fills the space such that the winding portions running in the receiving groove are completely embedded. In particular, spaces within the winding portions are also filled by the filling. In particular, the filling is also in positive contact with the rotor teeth and/or the winding portions in the circumferential direction.

In particular, the rotor is not equipped with permanent magnets for generating an excitation field. In particular, the rotor is externally excited. The rotor winding is in particular configured as an excitation winding. In particular, the receiving grooves (relative to their longitudinal axis) run in the axial direction. The winding portions are in particular wound on the support portion.

The rotor device is in particular provided for a traction motor for a vehicle that is at least partially electrically powered and, for example, for an electric vehicle and/or a hybrid vehicle. A vehicle with a rotor device according to embodiments of the invention can be provided. An (externally excited) electric machine with a rotor device according to an embodiment of the invention can be provided.

In particular, the filling comprises at least one electrically insulating casting compound. The filling is introduced in particular by a casting process. The filling can also be referred to as a mold. The filling is in particular produced by a casting process and preferably by injection molding. In particular, the collar portions of adjacent rotor teeth provide an undercut so that the filling can no longer leave the receiving grooves after the casting process. The filling is used in particular to close the receiving grooves.

In particular, the collar portions of rotor teeth that are adjacent in the circumferential direction at least partially close the receptacle groove running below them in the radial direction. In particular, the respective filler received in a receiving groove is positively secured by the collar portions of the rotor teeth, between which the receiving groove runs. In particular, the collar portion of a rotor tooth closes two adjacent receiving grooves, which are separated from each other by the rotor tooth, at least partially radially outwards. In particular, the distance between opposing collar portions is less than between opposing support portions. In particular, the width of the receiving groove between the support portions relative to the circumferential direction is less than between the collar portions.

Further advantages and features of the present invention follow from the example embodiments, which are described below with reference to the accompanying drawings.

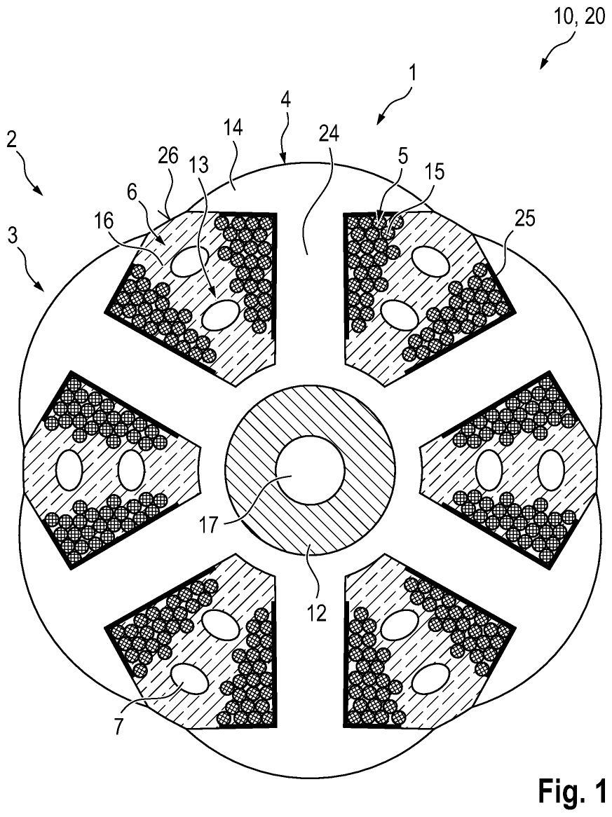

FIG. 1 shows a rotor device 1 according to the invention of an externally excited electric machine 10 and, for example, an externally excited synchronous motor 20. The rotor device 1 comprises a rotor 2 and a rotor shaft 12, which is rotatably mounted on a stator. The rotor 2 comprises a rotor base body 3 with a plurality of rotor teeth 4 and receiving grooves 13 running between the rotor teeth 4.

A rotor winding 5 is received on the rotor teeth 4, the winding portions 15 of which run into the receiving grooves 13. The rotor teeth 4 each comprise a support portion 24 and an axially outward adjoining collar section 14. A groove insulation 25 is arranged between the rotor teeth 4 and the winding portions 15.

In the receiving grooves 13, there is a filling 6 made of an electrically insulating material (e.g., a duromer or thermoplastic). The filling 6 serves to fix the rotor winding 5 and to close the receiving grooves 13. The filler 6 is positively secured by the collar portions 14 in the receiving groove 13.

The collar portions 14 absorb the centrifugal forces occurring during operation and transfer them radially inwards into the rotor base body 3 via the support portions 24. As a result, the rotor device 1 shown here does not require a component positively inserted between the rotor teeth 4 to cover the receiving grooves or, for example, a cover slide. In addition, additional components for winding fixation can also be omitted. Filling 6 and its positive securing thus allow functional integration of several components.

Elimination of a metallic cover slide also has the advantage that there is no negative influence on the electromagnetic properties of the machine 10. Due to the higher insulation properties of the filling 6, the overall structure is also particularly compact (lower layer thickness). In addition, the design of the rotor device 1 shown here allows for an optimized thermal connection of the entire rotor winding 5.

Between the opposing collar portions, the filler 6 has an exposed bridge surface 26 which is not positively secured by the collar portions 14. In order to be able to dissipate the forces acting on the winding portions 15 and the filling 6 during operation in a particularly targeted manner, the bridge surface 26 is equipped with a radially inwardly curved (concave) trough 36, for example.

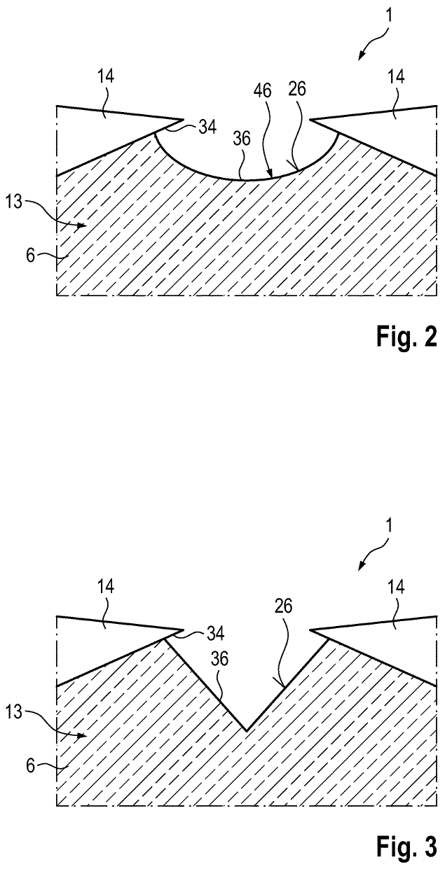

An example of such a trough 36 is shown in FIG. 2.

In an advantageous configuration, the bridge surface 26 or the trough 36 can be equipped with a bionically optimized geometry 46. Such geometry provides the ideal tactile path.

Additionally or alternatively, the collar portions 14 can project beyond the bridge surface 26 in sections, the bridge surface 26 being spaced apart from the collar portions 14. Such an embodiment can be seen, for example, in FIG. 2 and also in FIG. 3. There, the bridge surface 26 is projected from a terminal portion 34 of each of the collar portions 14.

In FIG. 3, a bridge surface 26 that recedes radially inwards in a V-shape is shown. In the example shown here, the side surfaces meet at an acute angle at the deepest point of the trough 36.

In the rotor device 1 shown in FIG. 1, cooling channels 7 are formed in the filling 6. Two parallel cooling channels 7 run in each of the receiving grooves 13. The cooling channels 7 are supplied with a cooling fluid, for example liquid, via a supply channel 17 running in the rotor shaft 2. The cooling channels 7 are arranged radially below the respective bridge surface 26. The winding portions 15 are thus particularly reliably and effectively cooled. Due to the increased heat dissipation, higher outputs of the machine 10 are possible.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A rotor device for an externally excited electric machine, comprising at least one rotor with a rotor base body with a plurality of rotor teeth,
wherein axially extending receiving grooves are arranged for receiving at least one winding portion of a rotor winding wound on the rotor teeth between the rotor teeth,
wherein a filling for fixing the rotor winding is arranged in the receptacle grooves, and
wherein the rotor teeth comprise at least one collar portion at their radially outer end, which positively secures the filling in the receiving groove.

2. The rotor device according to claim 1, wherein the collar portions of the rotor teeth positively secure the filling from centrifugal forces occurring during an intended operation and wherein the filling is configured to withstand the centrifugal forces.

3. The rotor device according to claim 1, wherein the rotor teeth each comprise at least one support portion limiting the receiving groove in a circumferential direction,
wherein the winding portion extends on the support portion,
wherein the collar portion adjoins the support portion radially outwards, and
wherein the collar portion projects beyond the support portion in the circumferential direction and partially closes the receiving groove radially outward.

4. The rotor device according to claim 1, wherein the filling comprises bridge surfaces which extend in each case between the collar portions of rotor teeth which are adjacent in the circumferential direction and do not touch the collar portions.

5. The rotor device according to claim 4, wherein the bridge surfaces are each configured to be recessed.

6. The rotor device according to claim 4, wherein the bridge surfaces each comprise a radially inwardly curved trough.

7. The rotor device according to claim 4, wherein the bridge surfaces are curved radially inwards in a parabolic shape.

8. The rotor device according to claim 4, wherein the bridge surfaces extend radially inwards in a V-shape.

9. The rotor device according to claim 4, wherein the bridge surfaces comprise a bionically optimized geometry.

10. The rotor device according to claim 4, wherein the collar portions project beyond the bridge surfaces in sections, the bridge surfaces being spaced apart from the collar portions opposite.

11. The rotor device according to claim 1, wherein at least one cooling channel for cooling the rotor is configured in the filling.

12. The rotor device according to claim 11, comprising at least one rotor shaft, wherein the at least one cooling channel can be supplied with a cooling fluid via a supply channel extending in the rotor shaft.

13. The rotor device according to claim 4, wherein the at least one cooling channel is formed at least in sections below the bridge surfaces.

14. The rotor device according to claim 1, wherein the filling embeds the winding portions and fills a space between the winding portions extending in the receiving grooves.

15. The rotor device according to claim 11, wherein the at least one cooling channel in the filling extends in an axial direction in at least some of the receiving grooves.

16. The rotor device according to claim 1, wherein the externally excited electric machine is an externally excited synchronous motor.
